(19) United States
(12) Patent Application Publication
(10) Pub. No.: US 2016/0253516 A1
(43) Pub. Date: Sep. 1, 2016

(54) CONTENT ENCRYPTION TO PRODUCE MULTIPLY ENCRYPTED CONTENT

(71) Applicant: HEWLETT-PACKARD DEVELOPMENT COMPANY, L.P., Houston, TX (US)

(72) Inventors: Michael Beiter Beiter, Fr. Collins, CO (US); Gustavo Kuhn Andriotti, Porto Alegre (BR); SANDRO RAFAELI, Plano, TX (US)

(21) Appl. No.: 15/032,285

(22) PCT Filed: Nov. 1, 2013
(86) PCT No.: PCT/US2013/068030

§ 371 Date: Apr. 26, 2016

(51) Int. Cl. G06F 21/62; H04L 9/14

(52) U.S. Cl. CPC G06F 21/6218; H04L 9/14

(57) ABSTRACT

Examples herein disclose receiving encrypted content encrypted with a first key. The examples disclose receiving a second key associated with the encrypted content, wherein the second key is a different encryption key from the first key. Additionally, the examples disclose encrypting the encrypted content with the second key to produce multiply encrypted content.

### BACKGROUND

Encrypted data management system may protect data by applying cryptography for data encryption prior to transmission and/or storage.

### BRIEF DESCRIPTION OF THE DRAWINGS

In the accompanying drawings, like numerals refer to like components or blocks. The following detailed description references the drawings, wherein:

FIG. 1 is a block diagram of an example data encryption system including a controller which encrypts content with a first key and transmits the encrypted content and a second key to a storage provider to produce multiply encrypted content;

FIG. 2 is a block diagram of an example data encryption system including a content provider to provide a first encrypted content with a second key to a first storage provider, the content provider is to provide a second encrypted content with a third key to a second storage provider, and a client to receive multiply encrypted content from the storage provider and multiple keys from the content provider;

FIG. 3 is a flowchart of an example method to receive content which is encrypted with a first key, the method receives a second key and encrypts the encrypted content with a second key to obtain multiply encrypted content;

FIG. 4 is a flowchart of an example method to receive encrypted content and based upon a revocation access to the encrypted content, the method receives a second key for producing multiply encrypted data with the second key;

FIG. 5 is a flowchart of an example method to encrypt encrypted content with a second key by generating a key stream, determining lengths of the key stream and the encrypted content to pad the encrypted content with additional data;

FIG. 6 is a flowchart of an example method to receive encrypted content and based on a revocation of access to the encrypted content, the method produces multiply encrypted content and based on a revocation of the multiply encrypted data, the method receives a third key; and

FIG. 7 is a block diagram of an example computing device with a processor to execute instructions in a machine-readable storage medium for receiving encrypted content and second key to produce multiply encrypted content.

### DETAILED DESCRIPTION

Encryption of content may include the process of encoding data in such a way that prevents adversaries from reading the underlying content, yet enables an authorized party to read the content. The content (also referred to as plaintext) is encrypted by turning the content into unreadable ciphertext with the use of encryption keys. The encryption keys specify how the content should be encoded. In this manner, the adversary may see the ciphertext (i.e., encrypted content) but should not be able to determine content of the original message. The authorized party may decode the ciphertext using the encryption keys of which the adversary may not have access to.

Cloud storage providers have become more prevalent to store the underlying content; however, these storage providers may be considered untrusted as a content provider may not have control over how the storage provider encrypts the content. Thus, the content provider may encrypt the data with the encryption key prior to transmission to the storage provider. This encryption may raise security and resource issues. For example, if the encryption key is compromised, the original content or the underlying content may be accessible unless the encryption key is changed. In this example, the content provider may decrypt the encrypted content and then re-encrypt the content using a new key and uploading the re-encrypted content. This example takes much time and resources. Further, if the content becomes too large, this may limit the encryption system as the content provider may have to be located near the cloud storage to minimize latency due to an extensive content transfer.

To address these issues, examples disclosed herein generate multiply encrypted content. Generating multiply encrypted content preserves content security and also decrease time latency and other resource consumption. In the examples, content may be encrypted with a first key at the content provider, resulting in encrypted content. The encrypted content is received by a storage provider along with a second key which is associated with the encrypted content. The second key is a different encryption key from the first key, thus preventing the first key from being leaked and/or compromised. In this example, the storage provider may be considered an untrusted party in the protection of the original content. As such, the first key may be stored at the content provider and distributed to authorized parties, but withheld from the storage provider. This enables the content provider to maintain privacy and security of the first key, providing management and control over the security of the original content. Further, this increases security as the content is encrypted prior to transmission to the untrusted storage provider.

Additionally, the examples disclose encrypting the encrypted content at the storage provider using the second key, thereby producing the multiply encrypted content. Performing an additional encryption on the encrypted content at the storage provider decreases resources and latency as the encrypted content is already uploaded to the storage provider rather decrypting, re-encrypting, and then uploading content to the storage provider. This additionally prevents interruptions to the encrypted content as the encrypted content may already be uploaded to the storage provider.

Furthermore, some examples provided herein may revoke access to the encrypted content and/or multiply encrypted content. Revoking access to the encrypted content, enables the content provider to modify access to the original content. Based on this modification, the content provider generates an additional key which may be used at the storage provider to provide an additional encryption cycle to the content. In this example, the content provider may modify access to the original content by generating an additional key for encryption at the storage providing while also maintaining the previous key. Generating and maintaining the keys at the content provider allows the content provider much control over how the content is protected. Additionally, this implementation allows the content provider to distribute the multiple keys to the authorized parties for decryption.

In summary, examples disclosed herein generate multiply encrypted content while also preserving content security and decreasing time latency and other resources. Further, the examples disclosed herein provide much control and management over how the content is protected by generating and distributing keys, accordingly.

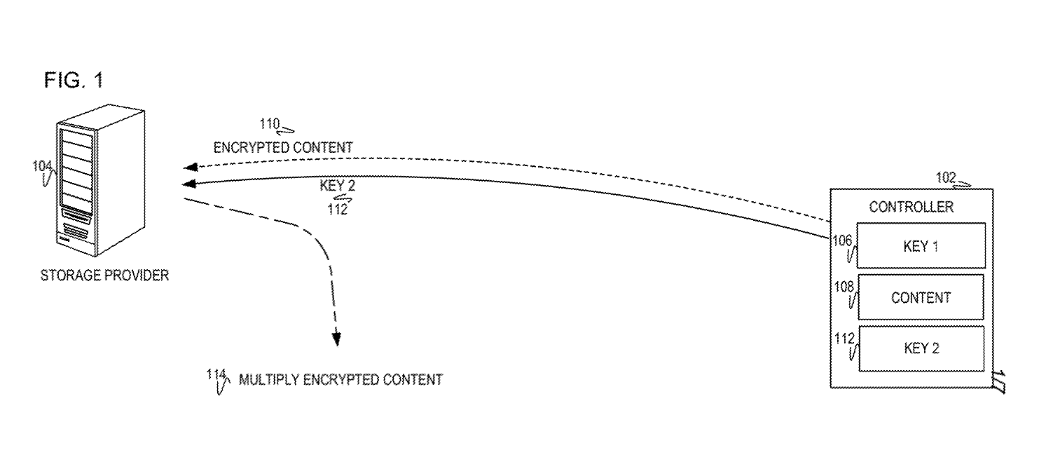

Referring now to the figures, FIG. 1 is a block diagram of an example data encryption system including a controller 102 which encrypts content 108 with a first key 106 to produce encrypted content 110. The controller 110 generates a second key 112 and transmits the encrypted content 110 and the second key 112 to a storage provider 104. The storage provider 104 encrypts the encrypted content 110 with the second key 112, thereby producing multiply encrypted content 114. The encryption system performs multiple encryptions on content 108 and may comprise a content provider with the controller 102, a storage provider 104, and/or client (e.g., authorized party). These components communicate with one another to encrypt the content 108 multiple times.

The controller 102 is associated with the content provider and as such, is considered a trusted component to protect the content 108 from unauthorized parties. As such, the controller 102 generates the multiple keys 106 and 108 for encrypting and decrypting the content 108. Additionally, the controller 102 may determine the authorized parties who may have access to the multiple keys 106 and 108 for decryption of the multiply encrypted content 114. In this implementation, the controller 102 as part of the content provider may modify access to the encrypted content 110 and/or the multiply encrypted content 114. In this implementation, the content provider may previously grant access for authorized parties (e.g., clients) to decrypt the encrypted content 110 by transmitting the first key 106 to the authorized parties. The content provider may revoke access to the encrypted content 110 by generating the second key 112 for encryption of the encrypted content 110 at the storage provider 104, thus the content provider may transmit both the first and the second keys to currently authorized parties. In this manner, modifying access to the encrypted content 110 and/or the multiply encrypted content 114 initializes an additional encryption cycle with an additional key. In this implementation, upon the modification, the controller generates an additional key which is not transmitted to the unauthorized party. Rather, the versions of the keys are transmitted to the authorized parties for decryption. This implementation increases efficiency of the encryption system as the encrypted content 110 and/or multiply encrypted content 114 may not go through decryption and re-encryption with the additional key. Further, this implementation prevents interruptions to the encrypted content 110 as after the first encryption cycle at the controller 102, the additional encryption cycles occur at the storage provider. This decreases a number of times to upload the encrypted content 110 to the storage provider 104. The controller may include an associated encryption module (not illustrated) to perform symmetric and/or asymmetric key encryption on the content 108 using the first key 108 to produce the encrypted content 110. In another implementation, the controller 102 may include an associated key generator (not illustrated) to generate the first key 106, second key 112, and/or additional keys. Implementations of the controller 102 include a computing system, electronic device, computing device, microprocessor, microchip, chipset, electronic circuit, semiconductor, microcontroller, central processing unit (CPU), or other type of computing system to the keys 106 and 112 and encryption of content 108.

The first key 106 is an encryption key used to encrypt the content 108 at the controller 102. The first key 106 is considered a cryptographic function that determines an output by specifying the particular transformation of the content 108 during encryption at the controller 102. The first key 106 is considered a different encryption key from the second key 112, meaning if the plaintext of the content 108 was encrypted by the first key 106 and then the plaintext of the content 108 was separately encrypted with the second key 112, these encryptions would not be similar. In one implementation, the first key 106 may be a different type of encryption technique than the second key 112. For example, the first key 106 may include a cipher function to encode the content 108, while the second key 112 may include a hashing function to encode the encrypted content 110. In a further example, the first key 106 may include a private key known by the controller 102 and authorized parties, while the second key 112 may include a public key. Including the first key 106 as a different encryption key from the second key 112, prevents the first key 106 from being compromised. Additionally, the first key 106 is stored at the controller 102 for transmission to the authorized parties. In this regard, the storage provider 104 may not receive the first key 106 as the storage provider 104 may be considered an untrusted and/or unauthorized party. Implementations of the first key 106 include a hash function, cipher function, symmetric key, asymmetric key, private key, cryptographic technique, cryptographic protocol, or other type of cryptographic function that encodes the content 108 to produce the encrypted content 110.

The content 108, also referred to as the plaintext, is data in which the content provider associated with the controller 102 may desire to limit access for privacy and/or security reasons. As such, the content 108 may be encrypted multiple times to protect its data. In one implementation, the content 108 may be divided into smaller chunks of data, thereby increasing a speed of encryption. For instance, through parallelized processing of the smaller chunks of data, the speed may be increased. This implementation is explained in detail in a later figure.

The second key 112 is an encryption key used to encrypt the encrypted content 110 at the storage provider 104. The second key 112 is considered a cryptographic function that determines an output (i.e., multiply encrypted content 114) by specifying the particular transformation of the encrypted content 110 during encryption at the storage provider 104. As explained in relation to the first key 106, the second key 112 is a different encryption key from the first key 106 to encrypt the encrypted content 110. In this implementation, using the second key to encrypt the encrypted content 110 is considered an additional encryption cycle, hence producing the multiply encrypted content 114. Implementations of the second key 112 include a hash function, cipher function, symmetric key, asymmetric key, private key, cryptographic technique, cryptographic protocol, or other type of cryptographic function that encodes the encrypted content 110 to produce the multiply encrypted content 114.

The encrypted content 110 is produced at the content provider associated with the controller 102. The encrypted content is the result of encrypting the content 108 with the first key 106. As such, the encrypted content 110 is considered the first cycle of encryption of the content 108.

The storage provider 104 is a computing system to provide network services, such as data storage and/or Internet connectivity. As such, the storage provider 104 may operate as a cloud storage provider in which data is stored. The storage provider 104 ma be considered an untrusted party, meaning the storage provider 104 may not be trusted to protect the content 108 from unauthorized parties. Thus, the storage provider 104 may not have access to the first key 106 and thus may not have access to the plaintext of the encrypted content 110. Although FIG. 1 illustrates a single storage provider 104, implementations should not be limited as this was done for illustration purposes. For example, FIG. 1 may include multiple storage providers to receive different chunks of encrypted content from the content provider associated with the controller 102. In this example, the content provider may divide the content 108 into different chunks of content, each of the different chunks of content may be encrypted using the first key. Each of the different encrypted chunks of data may be provided to the various storage providers, along with a different version of a key. Thus, each storage provider may produce a different encryption at each of the storage providers. This implementation may be explained in detail in the next figure. Implementations of the storage provider 104 include a Local Area Network (LAN) server, web server, cloud server, network server, file server, or other type of computing device capable of receiving the encrypted content 110 and the second key 112 to produce the multiply encrypted content 114.

The multiply encrypted content 114, produced at the storage provider 104, includes the content 108 encrypted at least twice. The content 108 is first encrypted at the controller 102 using the first key 106 to produce the encrypted content 110. The encrypted content 110 is encrypted a second time at the storage provider 104 with the second key 112, resulting in the multiply encrypted content 114. In one implementation, the multiply encrypted content 114 may be distributed among the authorized parties from the storage provider 104. During this implementation, the controller 102 may transmit the first key 106 and the second key 112 to the authorized parties for decryption. At the authorized parties, the multiply encrypted content 114 may be decrypted by generating a first key stream from the first key and a second key stream from the second key. Using the first key stream and the second key stream, the authorized party may merge the key streams for decrypting the multiply encrypted content 114.

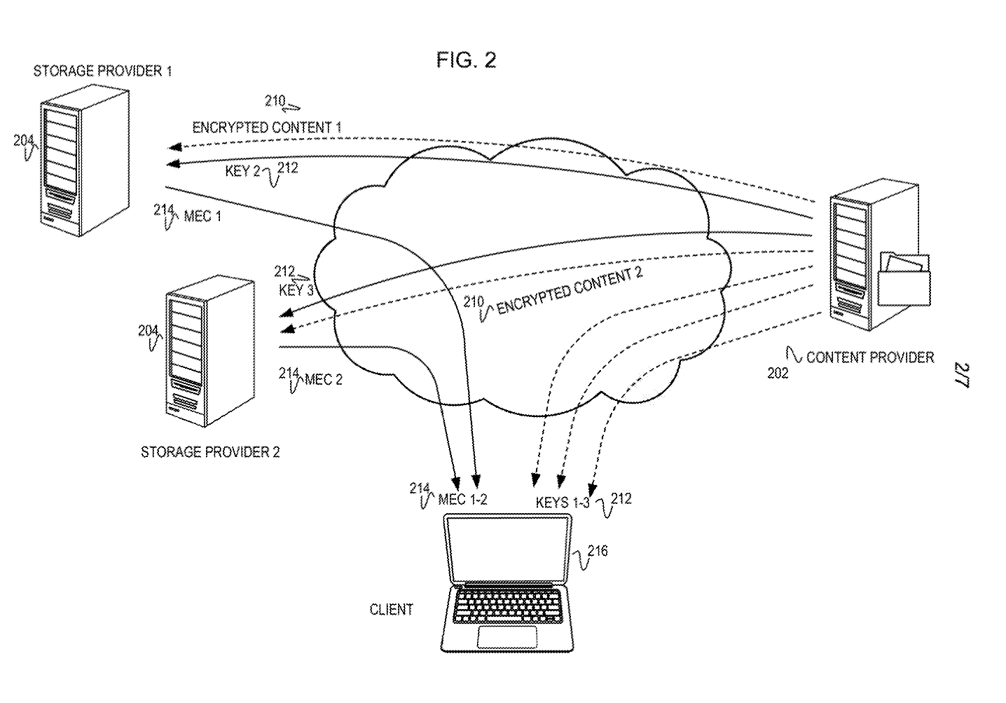

FIG. 2 is a block diagram of an example data encryption system including a content provider 202 to provide a first encrypted content (Encrypted Content 1) 210 with a second key (Key 2) 212 to a first storage provider (Storage Provider 1) 204. The content provider 202, also provides a second encrypted content (Encrypted Content 2) 210 with a third key (Key 3) 212 to a second storage provider (Storage Provider 2) 204. The content provider 102 further transmits multiple versions of the encryption keys (Keys 1-3) 212 to an authorized party (Client) 216. The client 216 may be authorized to view the original content and as such receives the multiple keys 212 to decrypt the multiply encrypted content (MEC 1-2) 214 from each of the storage providers 204. Specifically, FIG. 2 illustrates the encryption system to securely store content with untrusted storage providers (Storage Provider 1 and Storage Provider 2) 204.

In FIG. 2, the content provider may split content (e.g., plaintext) into chunks of content which may independently be encrypted with a first key (Key 1) to obtain various encrypted content (Encrypted Content 1 and Encrypted Content 2) 210. Each of these encrypted content chunks (Encrypted Content 1-2) 210 are uploaded or transmitted to each of the storage providers 204 with a different encryption key (Key 2 and Key 3), respectively. Each of the storage providers 204 use their respective encryption key 212 to produce the different multiply encrypted content 214. For example, the content provider 202 may include a first chunk of content which may be encrypted with the first key (Key 1) to obtain the first encrypted content (Encrypted Content 1) 210. The first encrypted content 210 is then transmitted to the first storage provider (Storage Provider 1) 204. The first storage provider 204 may then receive the second key (Key 2) 212 from the content provider 202 and encrypts the first encrypted content (Encrypted Content 1) 210 using the second key 212, thus resulting in the first multiply encrypted content (MEC 1) 214. In another example, the content provider 102 may include a second chunk of content which may be encrypted with the first key (Key 1) to obtain the second encrypted content (Encrypted Content 2) 210. The second encrypted content 210 is then transmitted to the second storage provider (Storage Provider 2) 204. The second storage provider 204 may then receive the third key (Key 3) 212 from the content provider 202 and encrypts the second encrypted content 210 using the third key 212, thus resulting in the second multiply encrypted content (MEC 2) 214.

Completing an additional encryption on the content at each of the storage providers 204 enables a modification of one of the keys (KEYS 1-3) 212 and/or modification of revoking access to a previously authorized party, by generating the additional key at the content provider 202 and then transmitting the additional key to at least one of the storage providers 204. This provides for the additional encryption of the content at the storage provider 204 side without consuming significant resources of the content provider 202. The content provider 202 transmits the additional key material to the storage provider 204 for the additional encryption without getting access to the original content and/or plaintext of the content. The content provider 202 controls access to the original content by encrypting the content with the first key and storing the first key without transmission to the storage provider 204. The content provider 202 may then transmit the versions of keys to the authorized parties, thereby controlling access to the original content.

Each of the storage providers 204 may in turn transmit the different multiply encrypted content (MEC 1-2) to the authorized party (client) 216 for decryption. The decryption of the different multiply encrypted content (MEC 1-2) is designed, such that, the client (authorized party) may not have to perform multiple decryption operations. Rather, the client creates multiple key streams from the multiple versions of the encryption keys (Keys 1-3) provided from the content provider. The multiple key streams may be merged, thus the merged resulting key stream may be used to decrypt the multiple encrypted content (MEC 1-2).

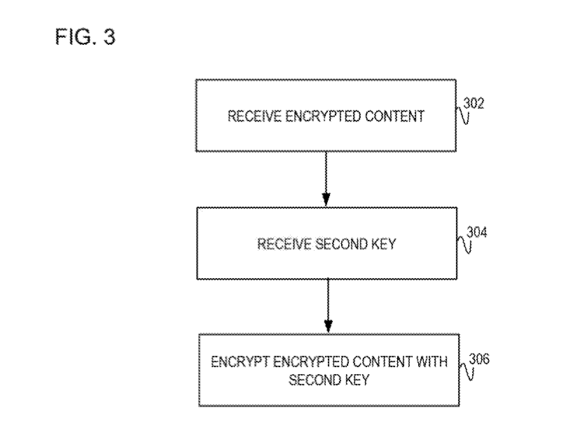

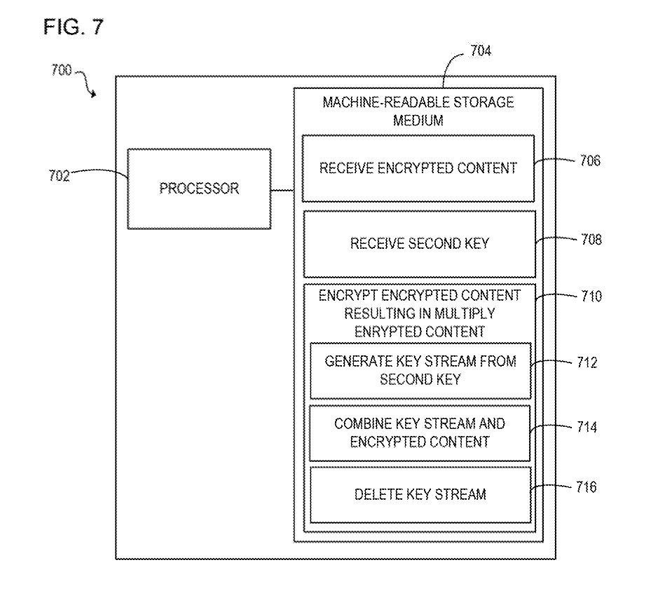

FIG. 3 is a flowchart of an example method to receive encrypted content and a second key to produce multiply encrypted content. The content is encrypted with a first key to produce the received encrypted content. The second key is used to encrypt the encrypted content, thereby producing the multiply encrypted content. In this implementation, the second key used to encrypt the encrypted content is a different encryption key from the first key which may be used to produce the encrypted content. Additionally, in this implementation, the content is encrypted with the first key at a content provider prior to transmitting the encrypted content and the second key. Further, the first key is withheld from transmission to a storage provider, while the second key is transmitted with the encrypted content to the storage provider. This implementation provides additional security by managing keys to appropriately authorized parties. The method may be executable by a controller 102 and/or processor associated with a storage provider 104 as in FIG. 1. In discussing FIG. 3, references may be made to the components in FIGS. 1-2 to provide contextual examples. In one implementation of FIG. 3, a storage provider 104 associated with a controller 102 and/or client within an encryption system as in FIG. 1, collaborates communications between these components to perform operations 302-306. Further, although FIG. 3 is described as implemented by the storage provider 104 and/or controller 102, it may be executed on other suitable components. For example, FIG. 3 may be implemented by a processor (not illustrated) or in the form of executable instructions on a machine-readable storage medium 704 as in FIG. 7.

At operation 302, the storage provider receives the encrypted content by the content provider. In one implementation, the content provider may upload encrypted content to the storage provider. Encrypting the content prior to transmission to the storage provider, provides security when the storage provider may not be considered a trusted source. This implementation further enables the content provider additional control over the uploaded encrypted content by keeping at least one key from the storage provider (e.g., the first key). In another implementation, the content prior to encryption at the content provider may be chunked into data portions, thereby each data portion may be encrypted using the first key prior to transmission to the storage provider(s). In this implementation, the content provider may split encrypted content (e.g., payload) into chunks and upload to multiple storage providers. In a further implementation, upon receiving the encrypted content, the storage provider may store a copy of the encrypted content.

At operation 304, the storage provider receives the second key from the content provider. In this implementation, the content provider generates both the first and the second key, and yet transmits the second key to the storage provider while holding onto the first key. This implementation enables the content provider to maintain privacy and security of the first key. Providing the second key to the storage provider, the content provider may provide both the first and the second key to an authorized client. Further, this increases security as the content is encrypted when transmitted to the storage provider.

At operation 306, the storage provider encrypts the encrypted content with the second key to produce the multiply encrypted content. The storage provider receives the encrypted content from the content provider at operation 302 and may store the encrypted content until receiving the second key at operation 304. Receiving the second key, signals to the storage provider to initialize the encryption of the encrypted content with the second key. In another implementation, operation 306 may include a two-fold encryption. In this implementation, content is encrypted first at the content provider and transmitted to the storage provider. The storage provider may then encrypt the encrypted content to produce the multiply encrypted content. In one implementation, the storage provider generates a key stream from the second key. Using the key stream, the storage provider may compare lengths of both the key stream and the encrypted content. If the storage provider determines the encrypted content has fewer data variables than the key stream, the storage provider includes additional data variables into the encrypted content prior to the encryption of the encrypted content. This implementation is described in detail in a later figure. The additional encryption at operation 306 to produce the multiply encrypted content at the storage provider side enables the encryption without consuming significant resources of the content provider and/or encryption system. In another implementation of operation 304, the content provider which provides the encrypted content to the storage provider may transmit additional key material (e.g., the first and the second key) to an authorized client. The authorized client may receive the multiply encrypted content at operation 306 and using the first and the second keys, decrypt the multiply encrypted content.

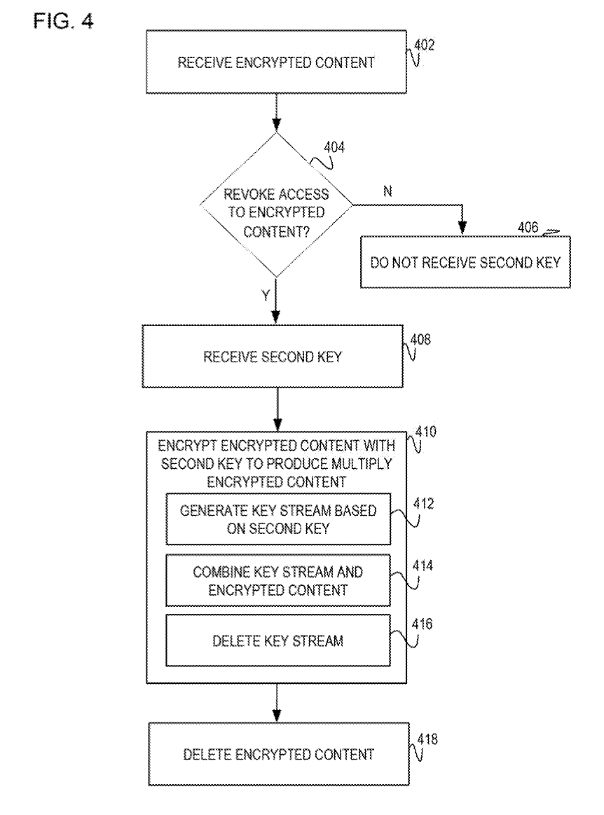

FIG. 4 is a flowchart of an example method to receive encrypted content and based upon a revocation access to the encrypted content, the method receives a second key for producing multiply encrypted data with the second key. Upon receiving the second key, the method uses the second key to encrypt the received encrypted content. The method generates a key stream and may then combine the key stream and the encrypted content to produce the multiply encrypted content. Upon producing the multiply encrypted content, the method may delete the key stream and the encrypted content. Access to the encrypted content may be revoked without redistributing the encrypted content and/or changing an encryption key, thereby saving encryption system resources. This implementation further enables modifying access to content without decrypting and re-encrypting content which takes much time and bandwidth to upload to the storage provider. The method may be executable by a controller 102 and/or processor associated with a storage provider 104 as in FIG. 1. In discussing FIG. 4, references may be made to the components in FIGS. 1-2 to provide contextual examples. In one implementation of FIG. 4, a storage provider 104 associated with a controller 102 and/or client within an encryption system as in FIG. 1, collaborates communications between these components to perform operations 402-418. The controller is considered a component of a content provider which may encrypt content with a first key prior to transmission to the storage provider. Further, although FIG. 4 is described as implemented by the storage provider 104 and/or controller 102, it may be executed on other suitable components. For example, FIG. 3 may be implemented by to processor (not illustrated) or in the form of executable instructions on a machine-readable storage medium 704 as in FIG. 7.

At operation 402, the storage provider may receive encrypted cement from the content provider. In this implementation, the content provider generates two keys (i.e., the first and the second key). The first key is used by the content provider to encrypt content prior to transmission to the storage provider. In this implementation, the encrypted content is transmitted to the storage provider while the first key is not transmitted to the storage provider. Encrypting the content at the content provider manages security of the encrypted content by controlling access to the keys. Operation 402 may be similar in functionality to operation 302 as in FIG. 3.

At operation 404, the content provider may determine whether to revoke access to encrypted content. Untrusted and/or unauthorized parties may not be trusted to protect data content, thus these parties, may not have access to the keys (i.e., the first key and the second key) which may be used to decrypt the encrypted content and/or multiply encrypted content. The content provider may modify access to encrypted content for many reasons, some of which may include: the keys may include expiration dates; one of the keys may have been compromised; or an authorized party may no longer have authorization to read the content. Or in a further example, if one of the keys has been compromised and/or the content provider may desire to dis-enroll a client that was previous authorized for access to the encrypted content. Once the content provider determines to modify access to the encrypted content, the content provider may generate the second key for encryption the storage provider. Modifying access to the encrypted content, the content provider generates an additional key (e.g., the second key) for encryption at the storage provider while maintaining the original key (e.g., the first key). Thus, the content provider may transmit both the keys to the authorized parties for decryption. If the content provider determines not to revoke the access to the encrypted content, the content provider may not transmit the second key as at operation 406. If the content provider revokes access or modifies access to the encrypted content, the storage provider proceeds to operation 408 to receive the second key. Thus, the content provider may generate the second key which is restricted from the unauthorized parties and transmitted to the authorized parties.

At operation 406, the storage provider may not receive the second key from the content provider. In this implementation, the content provider may determine to not revoke access or modify access to the encrypted content. In this implementation, the parties with access to the encrypted content may decrypt the encrypted content with the first key, thus the storage provider may transmit the encrypted content to the authorized parties without the first key. The content provider may then transmit the first key to the authorized parties, but not to the storage provider. The reason for transmitting the first key to the authorized parties, but not the storage provider, is it is assumed the storage provider is an untrusted party which may not protect the content.

At operation 408, upon determining to revoke access to the encrypted data, the content provider generates the second key which is transmitted to the storage provider. The storage provider may utilize the second key to encrypt the encrypted data from the content provider, thus producing an at least-two fold encrypted content, also referred to as the multiply encrypted content. Restricting access to the first key, but providing the second key to the storage provider, enables the content provider to control access to the content. For example, the storage provider receives the content encrypted, but may not be able to read the underlying content as the storage provider may not have access to the first key. Providing the second key to the storage provider enables an additional encryption cycle for producing the multiply encrypted content at operation 410. Operation 408 may be similar in functionality to operation 304 as in FIG. 3.

At operation 410, the storage provider encrypts the encrypted content with the second key received at operations 402 and 408 to produce the multiply encrypted content. In one implementation, the storage provider may delete the encrypted content at operation 418 upon producing the multiply encrypted content. In another implementation, the storage provider may perform operations 412-414 to produce the multiply encrypted content. In this implementation, the storage provider generates the key stream from the second key, combines the generated key stream and the encrypted content to produce the multiply encrypted content, and then the storage provider may delete the key stream. Operation 410 may be similar in functionality to operation 306 as in FIG. 3.

At operation 412, the storage provider generates the key stream based on the second key. The key stream is an expansion of the second key material and implementations may include an expansion of a key-password and/or pseudorandom characters. As such, the key stream may include string of variables which is combined with the encrypted content at operation 414 to produce the multiply encrypted content. For example, the second key may be converted into binary bits of data, thus generating the key stream.

At operation 414, the storage provider combines the key stream and the encrypted content to produce the multiply encrypted content. In an implementation, the storage provider may utilize logic to combine the key stream and the encrypted content. For example, the storage provider may perform an xor function to combine both the key stream and the encrypted content to obtain the multiply encrypted content.

At operation 416, the storage provider deletes the key stream generated at operation 412. In this operation, the storage provider may generate the key stream as at operation 412 and save a copy in storage, while the key stream is combined at operation 414. The key stream copy in the storage may then be deleted at operation 416 once producing the multiply encrypted content at operation 414.

At operation 418, the storage provider may delete the encrypted content received at operation 402. In this implementation, the storage provider may store a copy of the encrypted content at operation 402, thus once the encrypted content is used to produce the multiply encrypted content, the storage provider may delete the encrypted content. This further increases security by deleting the encrypted content after used to produce the multiply encrypted content.

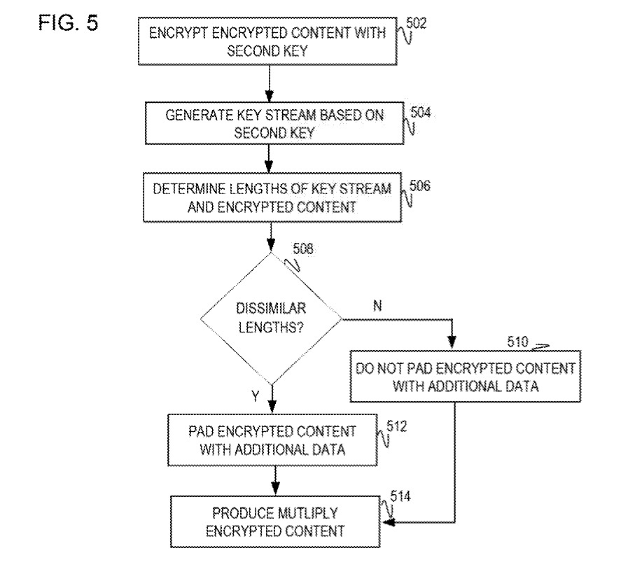

FIG. 5 is a flowchart of an example method to encrypt encrypted content with a second key by generating a key stream. The method may also determine lengths of the key stream and the encrypted content. Based upon the determination of the lengths of the key stream and the encrypted content, the method may pad the encrypted content with additional data. Padding the encrypted content with additional data ensures the encrypted content is the correct length to combine with the key stream to produce the multiply encrypted content. In discussing FIG. 5, references may be made to the components in FIGS. 1-2 to provide contextual examples. In one implementation of FIG. 5, a storage provider 104 associated with a controller 102 and/or client within an encryption system as in FIG. 1, collaborates communications between these components to perform operations 502-514. Further, although FIG. 5 is described as implemented by the storage provider 104 and/or controller 102, it may be executed on other suitable components. For example, FIG. 5 may be implemented by a processor (not illustrated) or in the form of executable instructions on a machine-readable storage medium 704 as in FIG. 7.

At operation 502-504, the storage provider receives the encrypted content for encryption with the second key to produce the multiply encrypted content. The storage provider generates a key stream from the second key for determining the lengths of the key stream and the encrypted content at operation 506. Operations 502-504 may be similar in functionality to operations 402 and 412 as in FIG. 4, respectively.

At operation 506, the storage provider may determine the length of the key stream generated at operation 504 and the length of the encrypted content at operation 502. In one implementation, the storage provider determines a number of variables within the key stream and the encrypted content. Upon determining the number of variables within the key stream and the encrypted content, the method proceeds to operation 508 to compare the lengths.

At operation 508, the storage provider compares the lengths of both the generated key stream at operation 504 and the encrypted content received at operation 502. Comparing the lengths, the storage provider may pad the encrypted content with additional data if the lengths are dissimilar as at operation 512. If the lengths are similar or equal, the storage provider proceeds to operation 510 and the encrypted content is not padded with additional data.

At operation 510, upon determining the lengths of the key stream and the encrypted content are similar (e.g., equal), the storage provider may not pad the encrypted content with additional data. The storage provider may not pad the encrypted content prior to combining the encrypted content and the generated key stream to produce the multiply encrypted content as at operation 514.

At operation 512, upon determining the lengths of the key stream and encrypted content are dissimilar, the storage provider pads the encrypted content with additional data. In this operation, the storage provider may fill up the encrypted content to fit a particular block size. In this manner, the storage provider may include addition& bits of data into a specific block of data (e.g., encrypted content) to reach a particular length of data bits. For example, if the encrypted content has a length of 15 bits, but the length of the key stream is 16 bits, an additional bit is added to the encrypted content. The padding ensures the encrypted content is the same length as the key stream to produce the multiply encrypted content as at operation 514.

At operation 514, the storage provider produces the multiply encrypted content. In one implementation, the key stream and the encrypted content are combined to form the multiply encrypted content.

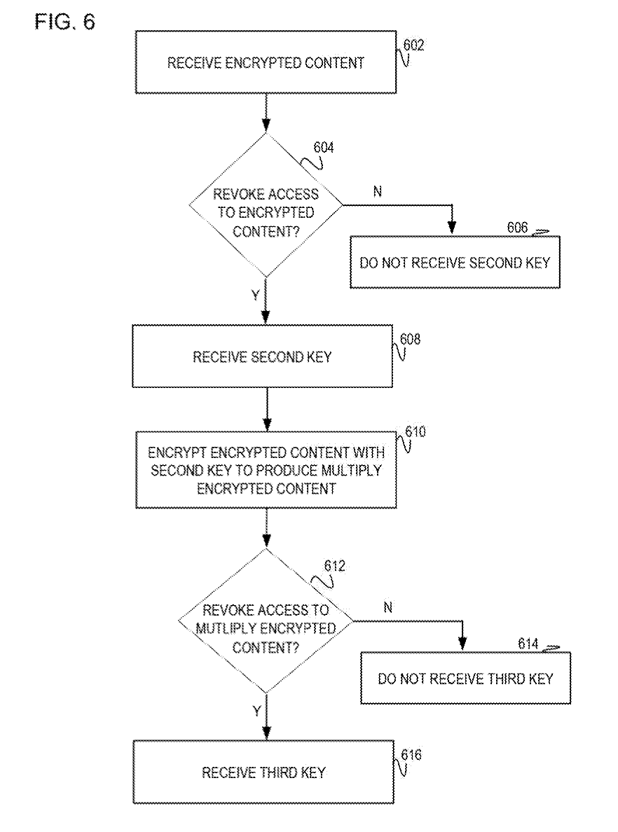

FIG. 6 is a flowchart of an example method to receive encrypted content and based on a revocation of access to the encrypted content, the method produces multiply encrypted content. Additionally, the method may decide to revoke access to the multiply encrypted content and based on this decision, the method receives a third key. FIG. 6 illustrates modifying access to content by a previously authorized party and generating an additional key based on the modification. This enables a content provider to generate the additional key for transmission to an authorized party. Additionally, generating the additional key based on the modification of access to the content enables a more efficient encryption cycle as the method may not decrypt and re-encrypt based on the modification. In discussing FIG. 6, references may be made to the components in FIGS. 1-2 to provide contextual examples. In one implementation of FIG. 6, a storage provider 104 associated with a controller 102 and/or client within an encryption system as in FIG. 1, collaborates communications between these components to perform operations 602-616. The controller is considered a component of the content provider which may encrypt content with a first key prior to transmission to the storage provider and determine whether to revoke access to the encrypted content and/or the multiply encrypted content. The content provider may also generate the multiple keys for transmission to authorized parties for decryption. Further, although FIG. 6 is described as implemented by the storage provider 104 and/or controller 102, it may be executed on other suitable components. For example, FIG. 6 may be implemented by a processor (not illustrated) or in the form of executable instructions on a machine-readable storage medium 704 as in FIG. 7.

At operations 602-610, the storage provider receives encrypted content and a second key from the content provider to obtain the multiply encrypted content. Specifically at operation 602, the content provider obtains content in the form of plaintext and encrypts the content with the first key. The content provider stores the first key and transmits the encrypted content to the storage provider. In one implementation, the storage provider may be considered an intrusted source to the content provider. In this implementation, the first key may be transmitted to authorized parties, but not the storage provider. In this implementation, the storage provider may access encrypted content rather than the original underlying content. Upon transmitting the encrypted content to the storage provider, the content provider may revoke access to the encrypted content and as such, generates a second key and stores the second key. The storage provider receives the encrypted content and may store until receiving the second key from the storage provider. Upon receiving the second key, the storage provider additionally encrypts the encrypted content, thereby resulting in the multiply encrypted content. Providing the additional encryption, the authorized parties receive the first and second keys from the content provider while the storage provider transmits the multiply encrypted content to the authorized parties for decryption. Operations 602-610 may be similar in functionality to operations 402-410 as in FIG. 4.

At operation 612, the content provider may revoke access to the multiply encrypted content produced at operation 610. In this operation, it may be assumed the multiply encrypted content was distributed to the previously authorized party. The content provider may desire to modify access to the previously authorized party. Thus to protect the content, the content provider may generate the third key at operation 516. Generating the third key and transmitting to the storage provider for an additional encryption cycle, the content provider may then provide the first key, the second key, and the third key to the authorized parties. The previously authorized party which was revoked, may have the first and the second key, thus the previously authorized party will be unable to fully decrypt the content. Upon determining to revoke access to the multiply encrypted content, the method proceeds to operation 616 to generate the third key. Upon determining not to revoke access to the multiply encrypted content, the method proceeds to operation 614.

At operation 614, upon no modification of access to the multiply encrypted content, the storage provider may not receive the third key. The content provider may determine to maintain access to the authorized parties and in turn, decide to not complete an additional encryption cycle.

At operation 616, the storage provider may receive the third key from the content provider. In this operation, the content provider may generate the third key for the storage provider to receive. Additionally, the content provider may then distribute the first, second, and third keys to authorized parties for decryption.

FIG. 7 is a block diagram of computing device 700 with a processor 702 to execute instructions 706-716 within a machine-readable storage medium 704. Specifically, the computing device 700 with the processor 702 is to receive encrypted content from a content provider. The content provider encrypts the content with a first key prior to transmission. A storage provider receives the encrypted content and a second key and encrypts the encrypted content with the second key to produce multiply encrypted content. Although the computing device 700 includes processor 702 and machine-readable storage medium 704, it may also include other components that would be suitable to one skilled in the art. For example, the computing device 700 may include the controller 102 as in FIG. 1. The computing device 700 is an electronic device with the processor 702 capable of executing instructions 706-716, and as such embodiments of the computing device 700 include a computing device, mobile device, client device, personal computer, desktop computer, laptop, tablet, video game console, or other type of electronic device capable of executing instructions 706-716. The instructions 706-716 may be implemented as methods, functions, operations, and other processes implemented as machine-readable instructions stored on the storage medium 704, which may be non-transitory, such as hardware storage devices (e.g., random access memory (RAM), read only memory (ROM), erasable programmable ROM, electrically erasable ROM, hard drives, and flash memory.

The processor 702 may fetch, decode, and execute instructions 706-716 receive encrypted content and the second key to produce multiply encrypted content, accordingly. In one implementation, once executing instructions 706-708, the processor may execute instruction 710 by executing instructions 712-714. In another implementation, once executing instructions 706-714, the processor may execute instruction 716. Specifically, the processor 702 executes instructions 706-708 to: receive encrypted content from the content provider, the encrypted content is encrypted using a first key prior to receiving the encrypted content; and receive a second key from the content provider but not the first key. The processor 702 may then execute instruction 710 to encrypt the encrypted content using the second key. The processor 702 may execute instruction 710 by executing, instructions 712-714 to: generate a key stream from the second key; and combine the key stream and the encrypted content to produce the multiply encrypted content. Additionally, the processor 702 may execute instruction 716 to delete the key stream generated at instruction 710 upon producing the multiply encrypted content at instruction 714.

The machine-readable storage medium 704 includes instructions 706-716 for the processor 702 to fetch, decode, and execute. In another embodiment, the machine-readable storage medium 704 may be an electronic, magnetic, optical, memory, storage, flash-drive, or other physical device that contains or stores executable instructions. Thus, the machine-readable storage medium 704 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 704 may include an application and/or firmware which can be utilized independently and/or in conjunction with the processor 702 to fetch, decode, and/or execute instructions of the machine-readable storage medium 704. The application and/or firmware may be stored on the machine-readable storage medium 704 and/or stored on another location of the computing device 700.

In summary, examples disclosed herein generate multiply encrypted content while also preserving content security and decreasing time latency and other resources. Further, the examples disclosed herein provide much control and management over how the content is protected by generating and distributing keys, accordingly.

We claim:

1. A non-transitory machine-readable storage medium encoded with instructions executable by a processor of a computing device, the storage medium comprising instructions to:
receive encrypted content, the content encrypted with a first key;
receive a second key associated with the encrypted content based upon a revocation of access to the encrypted content, the second key is a different encryption key than the first key;
encrypt the encrypted content with the second key for producing a multiply encrypted content.

2. The non-transitory machine-readable storage medium including the instructions of claim 1 wherein to encrypt the encrypted content with the second key for producing the multiply encrypted content is further comprising instructions to:
generate a key stream horn the second key;
combine the key stream and the encrypted content resulting in the multiply encrypted content; and
delete the key stream based upon the resulting multiply encrypted content.

3. The non-transitory machine-readable storage medium including the instructions of claim 1 wherein to receive the second key associated with the encrypted content is without receiving the first key.

4. A system comprising:
a storage provider to:
receive encrypted content, the encrypted content decryptable by a first key;
receive a second key associated with the encrypted content;
encrypt the encrypted content with the second key, wherein the first key is a different encryption key from the second key; and
produce multiply encrypted content, the multiply encrypted content decryptable by the first key and the second key.

5. The system of claim 4 wherein the storage provider is without access to the first key, the system further comprising:
a client to:
receive the first key and the second key from the controller;
generate a first key stream and a second key stream from the first key and the second key, respectively;
decrypting the multiply encrypted content based on the first key stream and the second key stream.

6. The system of claim 4 wherein the storage provider is to encrypt the encrypted content with the second key, the storage provider is further to:
generate a key stream from the second key;
combine the key stream and the encrypted content to produce the multiply encrypted content.

7. The system of claim 4 further comprising:
a controller to:
provide the encrypted content to the storage provider;
provide the storage provider access to the second key without providing access to the first key; and
transmit the first key and the second key to a client.

8. The system of claim 7 wherein the controller is further to:
generate a third key based upon a revocation of access by the client to the multiply encrypted content;
transmit the third key to the storage provide for encryption of the multiply encrypted content; and
transmit the first key, the second key, and the third key to another client.

9. The system of claim 4 further comprising:
another storage provider to receive a third key, different from the first key and the second key, based upon a revocation of access to the multiply encrypted content, wherein the other storage provider is without access to the first key and the second key.

10. A method, executable by a storage provider, the method comprising:
receiving encrypted content, the content encrypted with a first key;
receiving a second key associated with the encrypted content, wherein the second key is a different encryption key from the first key; and
encrypting the encrypted content with the second key to produce multiply encrypted content.

11. The method of claim 10 wherein encrypting the encrypted content with the second key to produce the multiply encrypted content is comprising:
generating a key stream based on the second key;
combining the key stream and the encrypted content to produce the multiple encrypted content; and
deleting the key stream based upon the produced multiply encrypted content.

12. The method of claim 10 wherein receiving the second key associated with the encrypted payload is without receiving access to the first key, the method is further comprising:
revoking access, by a computing device, to the encrypted content.

13. The method of claim 10 further comprising:
deleting the encrypted content based on the production of the multiple encrypted content.

14. The method of claim 10 further comprising:
receiving a third key associated with the multiply encrypted content upon a revocation of access to the multiply encrypted content.

15. The method of claim 10 wherein encrypting the encrypted content with the second key to provide the multiply encrypted content is comprising:
generating a key stream from the second key;
determining a length of the encrypted content and a length of the key stream;
upon the determination the lengths are dissimilar, padding the encrypted content with additional data.
